(19) United States
(12) Patent Application Publication
(10) Pub. No.: US 2022/0058752 A1
(43) Pub. Date: Feb. 24, 2022

(54) SYSTEMS AND METHODS FOR REFERRAL MARKETING WITH MEDIA CONTENT UTILIZING AN ECHO PROCEDURE IN SOCIAL MEDIA NETWORKS

(71) Applicant: Kristen S. Candler, Enon, OH (US)

(72) Inventor: Kristen S. Candler, Enon, OH (US)

(21) Appl. No.: 17/001,540

(22) Filed: Aug. 24, 2020

(51) Int. Cl. G06Q 50/00; G06Q 30/02; G06Q 20/12; G06Q 30/06

(52) U.S. Cl. CPC G06Q 50/01; G06Q 30/0201; G06Q 20/123; G06Q 30/0215; G06Q 30/0273; G06Q 30/0214; G06Q 30/0631

(57) ABSTRACT

A media content referral marketing system and method is disclosed that functions as an Electronic Content Hortatory Operation (ECHO) system utilizing crowdsourcing in which rewards are distributed to lead users for marketing a publishing users media content to all lead user followers feeds. An ECHO allows a lead user to deliver a publishing lead users media content and/or product media CTA, to all of a lead users followers feeds and be paid rewards for all purchases derived from the Echo. Rewards are also distributed to publishing lead users for ad revenue generated with an ECHO of the publishing users content. The social media content referral marketing system corresponds with a social media network, social commerce, shared revenue and/or e-commerce system, with a follower/add friend system, in which a lead user becomes an intermediary user with the ability to perform an ECHO to amplify publishing users content.

### BACKGROUND OF THE INVENTION

### 1. Technical Field of Invention

This description relates to on-line media, social media, social networking media content and more particularly to applying an ECHO procedure and/or ‘ECHO technology’, i.e sharing (or re-sharing), reposting, redistributing, republishing, on-line media content from a lead user feed/host to all of a lead users followers feed. On-line service providers facilitate access to information and services, allowing users to navigate to desired resources, including on-line media, social media and social networking media content.

### 2. Description of the Prior Art

Briefly, the present invention relates to a media content referral marketing system and method, more particularly to a social media network Electronic Content Hortatory Operation (ECHO) system utilizing crowdsourcing in which rewards are distributed and/or provided to lead users for marketing a publishing users media content to the feed all of the lead users followers and be paid rewards for all purchases made by the lead users followers that are derived from the Echo. The amount of the reward paid to a lead user is based upon the number of purchases derived from the Echo. The system according to the invention will pay rewards to all lead users that perform an ECHO of a publishing users content thus incentivizing lead users to ECHO content consistently so that the lead users followers have the ability to ECHO the same media content for the purpose of amplifying the media content of interest to new audiences continuously.

Most users and brands usually face challenges when building audiences, reaching new customers and/or users and they often times look to generate capital with media content. However users with intimate understandings about social media, marketing and the habits of their followers and/or people in their social media network might be more successful with an ECHO system by taking advantage of a referral marketing opportunity for media content, product media Call to actions, services and/or products through their social media network.

This invention envisions lead users performing an ECHO for the purpose of amplifying media content from a publishing lead user, that the lead user is following, and republishing it to the feed of all the lead users followers whereas they then have the ability to perform an ECHO of that same media content and so on. Also envisioned is users marketing media content, product media Call to actions, products and/or services quickly and easily through their social media networks and being rewarded for purchases derived from an Echo.

The media content referral marketing Electronic Content Hortatory Operation (ECHO) invention will provide greater relevance to consumers, brands and/or businesses and social media users. Brands will be able to locate and/or find more customers because the the ECHO of their media content, product media Call to actions, product and/or service will reach more users than those solely in their social media network. Brands will also have the benefit of their products being delivered to buyers with a higher probability of purchase. Lead users that perform an ECHO of a publishing users media content, product media Call to action, product and/or service will be incentivized by cash commissions or other rewards.

In addition, the invention increases the relevance of referral marketing by incentivizing social media consumers and/or lead users to market media content, products and/or services of a publishing user to the feed of all a lead users followers that wouldn't otherwise reach those individuals. For example, a brand like Nike may have a significant amount of followers a social media network, with the ability for users to perform an ECHO Nike can reach new audiences outside of those users that are already following their profile. For instance Nike decides to post or publish media content or a product media Call to action or a product, the nike followers have the ability to ECHO the media content and/or product that they are viewing in their feed, republishing it to the feed of all of their followers therefor amplifying the media content and/or product beyond the Nike followers for rewards. Any user that experiences and/or interacts with and/or views the media content has the ability to ECHO it to their followers. The present media content referral marketing Electronic Content Hortatory Operation (ECHO) invention will provide significantly higher content engagements and ultimately more purchases as well for brands with a product by increasing the outreach by implementing a referral marketing system for social media users and rewarding them for collaborating and providing value.

Fewer than half of brands and/or companies doing social media marketing have a documented strategy. Also many brands are using social media but few have formalized their strategy. According to 45% of social media practitioners say identifying and understanding their target audience is their biggest challenge, the present invention increases the probability that the social media user finds their audience, increases engagement and as well consistently reaches new potential followers and/or customers. The present invention brings intentional strategies to social tech by capitalizing on consumer knowledge of social media, marketing, content distribution and networking. The present invention also brings user groups together to help them get network benefits from each other and generate economic value. Different from affiliate marketing, referral marketing is the method of spontaneously promoting a brands media content, products or services to new users and/or consumers.

### SUMMARY OF THE INVENTION

A media content referral marketing system and method is disclosed that functions as an Electronic Content Hortatory Operation (ECHO) system utilizing crowdsourcing in which rewards are distributed to lead users for marketing a publishing users media content to all lead users followers. An ECHO allows a lead user to republish media content, a product media CTA and/or a product, to all of a lead users followers and be paid rewards for all purchases derived from the Echo. In one example, rewards are also distributed to publishing lead users for ad revenue generated with an ECHO of the publishing users content. The social media content referral marketing system corresponds with a social media network, social commerce, shared revenue and/or e-commerce system, with a follower/add friend system, in which a lead user becomes an intermediary user with the ability to perform an ECHO amplifying a publishing users content. The lead user performs an ECHO to amplify the content of a publishing lead user and/or the content of interest, expanding the exposure of the content of interest by delivering the content to new audiences (i.e. the feed of all lead user followers) for incentives, and/or rewards, and/or revenue shares.

Also disclosed is a system and method for a social media content and/or product media CTA and/or product referral marketing, shared revenue and reward program that offers novel alternative incentives to users for referral marketing the media content and/or the product media CTA and/or the product, of users they follow and for attracting new users to new content and/or new product media CTA and/or products and/or new services and/or advertisements.

Also methods and systems are provided for performing an ECHO of a post in a lead users feed in an online social media environment and/or network. Social media are interactive computer mediated technologies that facilitate the creation or sharing of information, art, music, ideas, photos, videos, product media CTA and/or products, career interests and other forms of expression via virtual communities and networks.

A lead user may ECHO (i.e., share, re-share, post, repost, distribute, redistribute, publish, republish) any online media content from the lead users feed, and/or display view, with all of lead users followers. A lead user utilizes the ECHO function by identifying content of interest on the lead users feed, and/or display view, and/or system, then selects an icon to ECHO (i.e., share, re-share, post, repost, distribute, redistribute, publish, republish) the content in order to deliver the content to all of a lead users followers. Lead users enable all followers to experience, access, view and/or purchase the content of interest, making media from lead users feed, and/or display view, transferrable and viewable in all of a lead users followers feed, and/or display view. A lead user is any user authenticated by a host system, users in a follower system, users with followers, users viewing, and/or publishing media content and/or a product media CTA and/or a product, in a host system. A CTA is a call to action.

In one general aspect, a lead user may ECHO (i.e share, re-share, post, repost, distribute, redistribute) any on-line media content from a lead users feed and/or display with all lead user followers. A lead user utilizes the ECHO function by identifying content of interest on the lead users feed system, and/or display, then selects to ECHO (i.e., share, re-share, post, repost, distribute, redistribute) the content of interest in order to deliver the content to all lead users followers. A lead user enables all followers on the follower system to access, view, purchase from and/or experience the content of interest, making media from a lead users feed, and/or display, transferrable and viewable in all follower feeds.

Another general aspect an ECHO delivers media content of interest from a lead user to all followers and generates an ECHO status report that collects data and/or stores data and/or tracks data about revenues accumulated and/or earned/ and or generated from the Echoed media content of interest. An ECHO status report also tracks data and/or stores data and/or collects data corresponding to revenues earned from sales made and/or purchases made from the content of interest by followers.

Implementations may include one or more of the following features. For example, the content of interest may be identified by an icon on top of the lead users post that has been delivered to the followers feed. The followers will be enabled to experience, view, and access the content of interest automatically based upon a lead user to host communication.

An indication may be provided to the lead user of whether the followers have viewed, accessed, experienced (and/or made a purchase from) the on-line media content delivered. An indication may be provided to the follower if the follower has as well utilized the ECHO (i.e share, re-share, post, repost, distribute, redistribute) for the on-line media content of interest, previously Echoed (i.e shared, re-shared, posted, reposted, distributed, redistributed) by the lead user.

Further, an indication may be provided to the lead user of how many sales were generated, an indication may be provided to the lead user on how much revenue the ECHO generates, and an indication may be provided to the lead user on how the ECHO performs throughout the media contents life cycle.

Aspects of the ECHO may be implemented by an apparatus, system, a method and/or a program stored on a readable medium. The readable medium may comprise a client device, a host device, software, applications, program/software code, and/or a propagated signal. In addition. aspects of the ECHO may be implemented in a client/host context or in a standalone client device.

Other features will be apparent from the following description, including the drawings, and from the claims.

### DESCRIPTION OF THE DRAWING

These and other advantages of the present invention will be readily understood with reference to the following specification and attached drawing wherein:

FIGS. 1-4 are block diagrams of an exemplary communications system.

FIG. 5 is a flow chart of exemplary processes that may be implemented by systems such as those of FIGS. 1-4.

FIGS. 6-11 are illustrations of different graphical user interfaces that may be implemented by systems such as those of FIGS. 1-4 when executing processes such as those of FIG. 5. Like reference symbols in the various drawings indicate like elements. For brevity, several elements in the figures described below are represented as monolithic entities. However, as would be understood by one skilled in the art, these elements each may include numerous interconnected devices and components designed to perform a set of specified operations.

FIGS. 12-13 are block diagrams of an exemplary communications system.

FIG. 14 is a flow chart of exemplary processes that may be implemented by systems such as those of FIGS. 1-4 and FIGS. 12-13.

FIGS. 15-17 are block diagrams of an exemplary communications system.

FIGS. 18-19 are flow charts of an exemplary process that may be implemented by systems such as those of FIGS. 1-4 and FIGS. 12-13.

### DETAILED DESCRIPTION

A system and method for an social media network based, content referral marketing and reward program that offers novel alternative incentives to users for referral marketing the content of users they follow and for attracting new users to new content and/or a new product media CTA and/or products and/or new services and/or advertisements. Also methods and systems are provided for performing an ECHO of a post in a lead users feed in an online social media environment and/or network. Social media are interactive computer mediated technologies that facilitate the creation or sharing of information, art, music, ideas, photos, videos, product media CTA and/or products, career interests and other forms of expression via virtual communities and networks.

Embodiments consistent with the invention provide systems and methods for a lead user to perform a media content echo, republishing the media content of interest and/or post to all follower feeds. Methods and systems disclosed function as an Electronic Content Hortatory Operation (ECHO) corresponding with a social media monetization system in which a lead user becomes an intermediary user and performs an ECHO to amplify the content of interest to expose the content to new audiences, i.e. all lead user followers. Also an ECHO is a way for a lead user to deliver fresh content to followers in order to generate and/or stimulate traffic for advertisements and/or ad revenue and/or to provide additional content not published by a lead user for advertisement placement and ad revenue and/or to help a content publishing lead user reach more users by referral marketing content and/or to help the content publishing lead user generate more product media CTA and/or product sells for a reward and/or commission without the publishing lead user having to pay for additional exposure.

Rewards are provided to lead users for performing an ECHO and/or referral marketing media content and/or product media CTA and/or products to all followers for the purpose of reach and/or engagement and/or purchases.

An ECHO allows a lead user to push media content and/or product media CTA and/or products from the lead user feed to all lead user followers feed to earn rewards for all purchases and/or ad revenues that are derived from the ECHO reach and/or engagement.

The intermediary lead user can ECHO content to increase and/or drive additional traffic to a publishing lead users content and/or product media CTA and/or products in a manner that provides rewards and/or commissions and/or credit to the intermediary lead user, that created the echo. Rewards and/or commissions and/or credits are recorded and/or tracked in an ECHO status report when a follower of a lead user purchases a product media CTA and/or product and/or views the content a lead user chose to echo.

A percentage and/or a commission from and/or a reward from and/or a portion of the product media CTA and/or product sales are paid to lead users that performed an ECHO of the media content to all lead user followers.

Publishing lead user receives a reward for and/or commission from and/or a credit for and/or a percentage of, the ad revenue share for the traffic a lead user ECHO generates and/or becomes exposed to.

An ECHO status report keeps track of ad revenues derived from a post echo, the RPM or revenue per mille, CPM or click per mille, RPC or revenue per click and/or CTR or click through rate and also tracks the amplification rate or the rate at which lead users ECHO content of interest. Also the ECHO status report tracks purchases derived from an echo, commissions and/or rewards and/or credits earned from the content a lead user identifies and/or chooses and/or decides to echo.

An ECHO status report also includes an association between the publishing lead user and the lead user and all lead user followers that tracks the ECHO rewards and/or commissions owed to a lead user that the ECHO of a publishing lead users content generates, the ECHO status report also tracks rewards and/or commissions owed to the publishing lead user for ad revenues derived from the publishing lead users content in a lead user echo.

The ECHO status report tracks rewards and/or commission and/or credits and/or revenues earned in conjunction with the views and/or the reach and/or the engagement and/or the activities of the lead user followers (e.g., an ECHO and click through rate or how many people interact with and engage with a lead user ECHO and/or content of interest).

The invention relates to systems and methods that provide incentives to lead users that ECHO media content to all lead user followers feed amplifying the reach and/or exposure of the media content and/or to increase product media CTA and/or product sales and/or to generate revenue and/or to perform an ECHO to follower users that will also be incentivized to ECHO the media content as a lead user.

A user (e.g., a lead user) may desire to ECHO (i.e share, re-share, post, report, distribute, redistribute) with all followers, content of interest in the form of various on-line media content such as images, videos, memes, quizzes, polls, product media CTA and/or products, audio files, audio, articles, stories and other on-line media content which may be made available by accessing social media applications with content, social networking applications with content, on-line applications with content or otherwise.

The lead user may ECHO (i.e., share, re-share, post, repost, distribute, redistribute) the same media content that the lead user is viewing, experiencing, interacting with, accessing and/or purchasing, i.e. content of interest.

The followers may then view the content of interest and become the lead user with the ability to ECHO (i.e share, re-share, post, repast, distribute, redistribute) the same media content that the follower user is viewing, experiencing, interacting with, has accessed and/or has purchased, that the original lead user they are following has Echoed (i.e shared, re-shared, posted, reposted, distributed, redistributed).

The ECHO (i.e share, re-share, post, repost, distribute, redistribute) may include an identifier that is associated with the online media that is Echoed (i.e shared, re-shared, posted, reposted, distributed, redistributed) by the lead user, enabling lead user followers to know how the content of interest was delivered.

The ECHO (i.e share, re-share, post, repost, distribute, redistribute) may be delivered to the recipient, all followers, using a follower system application or protocol such as, for example, social media application, a social network application, a mobile application, a web application, a website and/or a game console.

The ECHO (i.e share, re-share, post, repost, distribute, redistribute) may be generated and delivered and/or pushed and/or sent manually by the lead user to all followers. In the event of an ECHO (i.e share, re-share, post, repost, distribute, redistribute) the media content being viewed by the lead user will also become viewable by all followers.

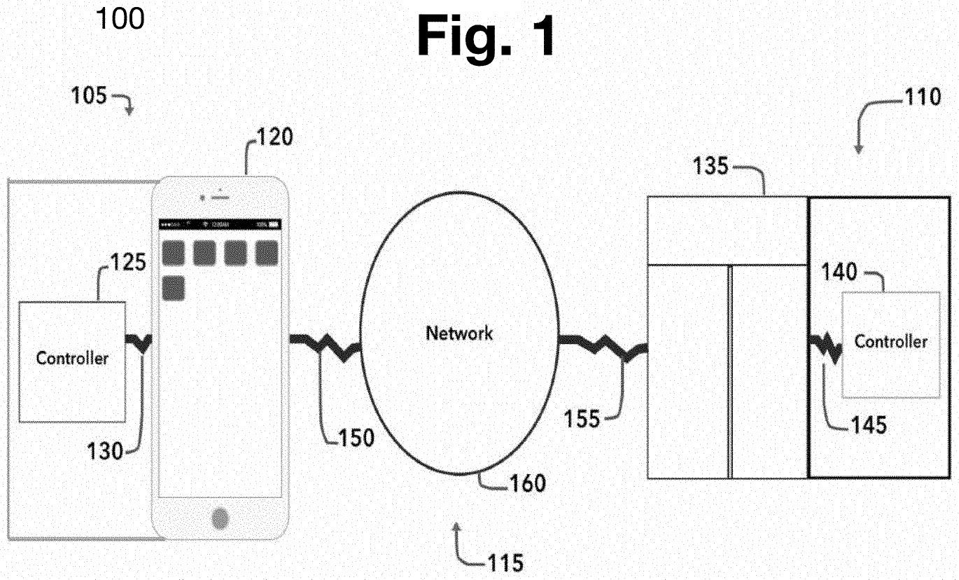

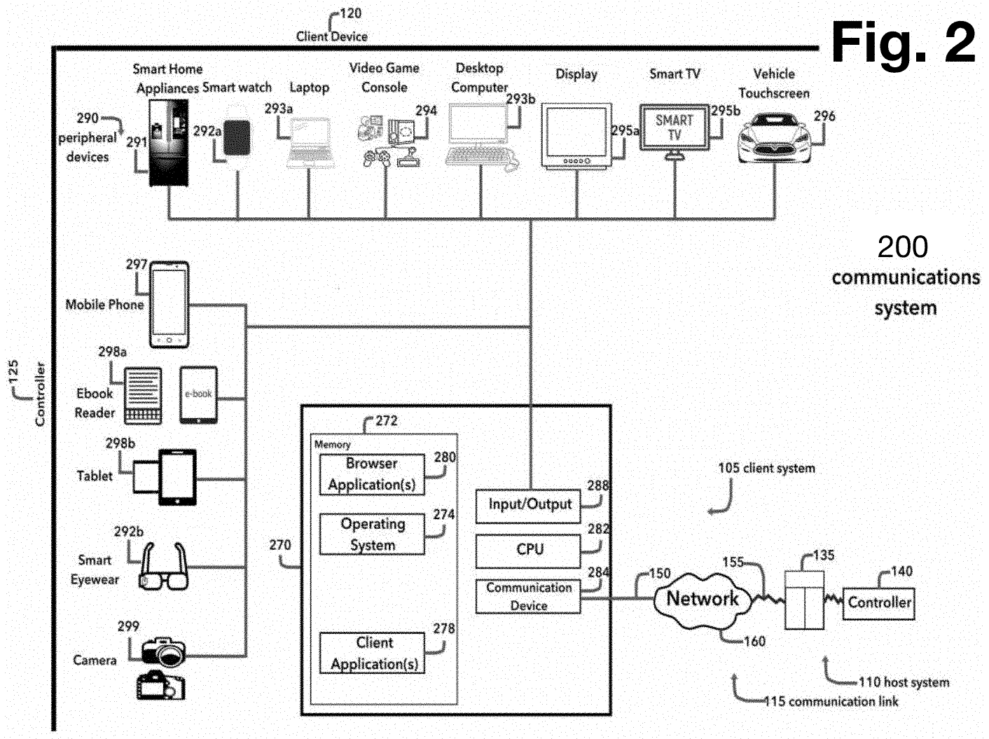

For illustrative purposes, FIGS. 1 and 2 show an example of a communications system for implementing techniques for Echoing (i.e sharing, re-sharing, posting, reposting, distributing, redistributing) media content from lead user to all followers. Referring to FIG. 1, a communications system 100 is capable of delivering and exchanging data between a client system 105, including a lead user system or a follower system, and a host system 110 through a communications link 115. The client system 105 typically includes one or more client devices 120 and/or client controllers 125, and the host system 110 typically includes one or more host devices 135 and/or host controllers 140. For example, the client system 105 or the host system 110 may include one or more general-purpose devices (e.g., smartphones, tablets, laptops, computers, smart tv's and/or game consoles).

The client device 120 and the host device 135 generally are capable of executing instructions under the command of, respectively, a client controller 125 and a host controller 140. The client device 120 and the host device 135 are connected to, respectively, the client controller 125 and the host controller 140 by data pathways 130 and 145, which are capable of delivering data.

The client device 120, the client controller 125, the host device 135, and the host controller 140 typically each include one or more hardware components and/or software components. An example of a client device 120 or a host device 135 is a general-purpose device (e.g., smartphones, tablets, laptops, computers, smart tv's and/or game consoles) or software on such a device capable of responding to and executing instructions in a defined manner. Other examples include a workstation, a kiosk, other physical or virtual equipment or some combination of these capable of responding to and executing instructions. The client device 120 and the host device 135 may include devices that are capable of establishing peer-to-peer communications.

An example of client controller 125 or host controller 140 is a software application loaded on the client device 120 or the host device 135 for commanding and directing communications enabled by the client device 120 or the host device 135. Other examples include a program, a piece of code, an instruction, a device, a computer, a computer system, or a combination of these for independently or collectively instructing the client device 120 or the host device 135 to interact and operate as described. The client controller 125 and the host controller 140 may be embodied permanently or temporarily in any type of machine, component, physical or virtual equipment, storage medium, or propagated signal capable of providing instructions to the client device 120 and the host device 135.

The communications link 115 typically includes a delivery network 160 that provides direct or indirect communication between the client system 105 and the host system 110, irrespective of physical separation. Examples of a delivery network 160 include the Internet; the World Wide Web and other delivery mechanisms for carrying data. The communications link 115 may include communication pathways 150 and 155 that enable communications through the one or more delivery networks 160 described above.

FIG. 2 illustrates a communications system 200 including a client system 105 communicating with a host system 110 through a communications link 115. The client system 105 includes a client device 120 that typically includes a general-purpose device 270 having an internal or external memory 272 for storing data and programs such as an operating system 274 and one or more application programs.

Examples of application programs include client applications 278 capable of communicating with other device users, accessing various device resources, and viewing, creating, or otherwise manipulating electronic content; and browser applications 280 capable of rendering standard Internet content and other content formatted according to standard protocols such as the Hypertext Transfer Protocol (HTTP).

Several communications applications and protocols, such as social media and/or social networking applications, may be used by communications system 200. Typically, social media communications involve an instantaneous or nearly instantaneous communication between users, where each user is able to transmit, receive and display media content.

Some examples of Echoing (i.e sharing, re-sharing, posting, reposting, distributing, redistributing) on-line media content are discussed below using social media applications, other implementations provide similar functionality in platforms and on-line applications such as software as a service.

One or more of the application programs may be installed on the internal or external storage 272 of the general-purpose device 270. Alternatively, in another implementation, the client controller 125 may access application programs externally stored in and/or performed by one or more device(s) external to the general-purpose device 270.

The general-purpose device 270 also includes a central processing unit 282 (CPU) for executing instructions in response to commands from the client controller 125, and a communication device 284 for sending and receiving data. The general-purpose device 270 may include an input/output interface 288 that enables wired or wireless connection to various peripheral devices 290. Examples of peripheral devices 290 include, but are not limited to, Smart home appliances 291, smart watch 292A, smart eyewear 292B, a laptop 293A, a desktop computer 293B, a video game console 294, a display monitor 295A with or without a touch screen input, a smart tv 295B, a vehicle touchscreen 296, a mobile phone 297, an ebook reader 298A, a tablet 298B, a camera 299 for receiving information from and rendering information to users.

Although FIG. 2 illustrates devices such as a mobile phone 297, a smart watch 292A, smart eyewear 292B, a camera 299, an ebook reader 298A, a game console 294 and a vehicle touchscreen 296 as being peripheral with respect to the general-purpose device 270, other implementations may have such devices themselves include the functionality of the general-purpose device 270 and operate as the client device 120.

For example, the smart eyewear 292B, the camera 299, the smartwatch 292A, the game console 294, the home appliance 291, the vehicle touchscreen 296 or the ebook reader 298A may include computing and networking capabilities and may function as a client device 120 by accessing the delivery network 160 and communicating with the host system 110. Furthermore, the client system 105 may include one, some or all of the components and devices described above.

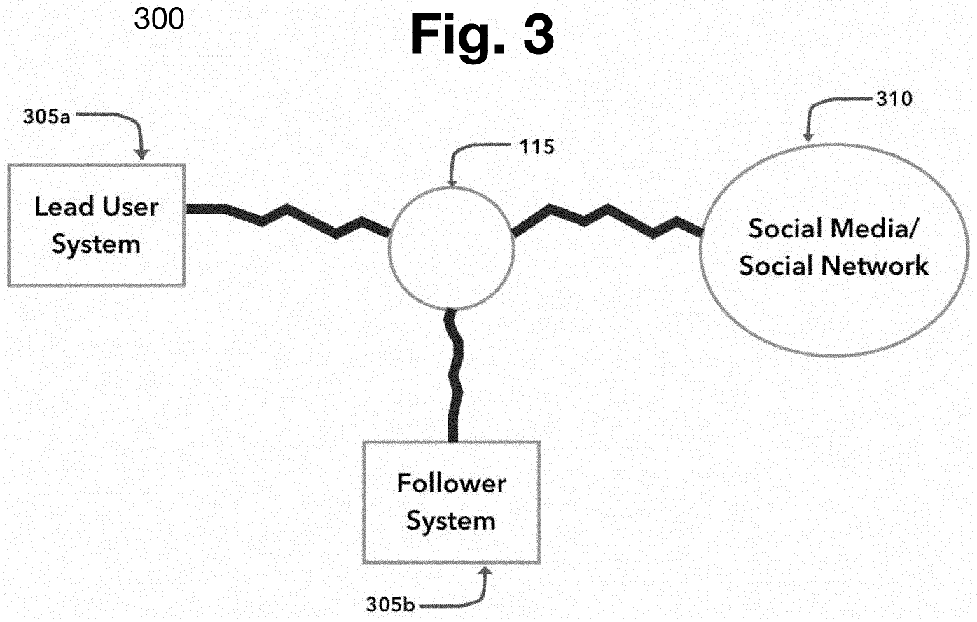

FIG. 3 illustrates a communications system 300 including a lead user system 305A communicating with a follower system 305B and a social media and/or social network host system 310 through a communication link 115. Such a communications system 300 may be available to users of social media and/or social network service providers.

The social media and/or social network host system 310 may have characteristics similar to those described above with respect to the host system 110, the lead user system 305A and the follower system 305B have characteristics similar to those described above with respect to the client system 105, and the lead user system 305A and the follower system 305B include communication software to enable users of the client systems to access the social media and/or social network host system 310.

To access the social media and/or social network host system 310 to utilize ECHO (i.e share, re-share, post, repost, distribute, redistribute) in the implementation of FIG. 3, the lead user system 305A establishes a connection to the social media and/or social network host system 310. Once a connection to the social media and/or social network host system 310 has been established. the lead user system 305A may transmit data (e.g. media content) to and access content from the social media and/or social network host system 310. By accessing the social media and/or social network host system, a lead user can use the social media and/or social network client application to ECHO (i.e share, re-share, post, repost, distribute, redistribute), track Echos (i.e., shares, re-shares, posts, reposts, distributes, redistributes), check ECHO (i.e share, re-share, post, repost, distribute, redistribute) status reports, follow users, create content, create product media CTA and/or products, upload content, participate in groups, find other users with similar interests, get customized information and other functions within social media and/or social network host systems.

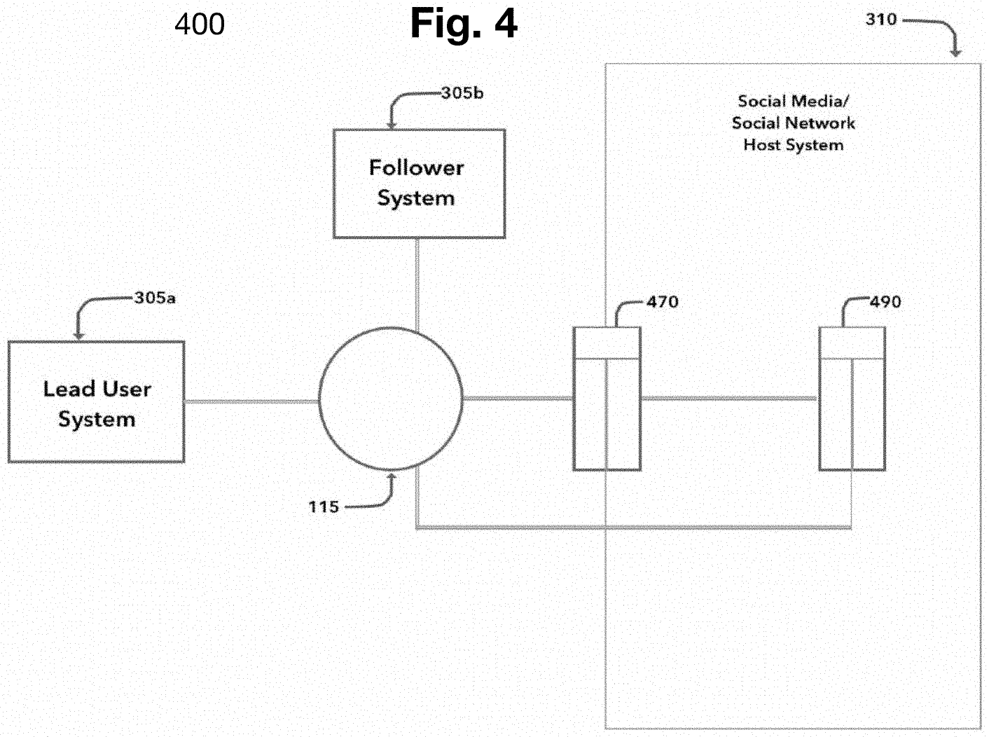

FIG. 4 illustrates a communications system 400 including a lead user system 305A communicating with a follower system 305B and a social media and/or social network host system 310 through a communication link 115. System 400 illustrates a possible implementation of the communications system 300 of FIG. 3.

In system 400, the social media and/or social network host system 310 includes a login server 470 for enabling access by users and routing communications between the lead user system 305A, the follower system 305B, and other elements of the social media and/or social network host system 310. The social media and/or social network host system 310 also includes a social media and/or social network server 490. To enable access to and facilitate interactions with the social media and/or social network host system 310, the lead user system 305A and the follower system 305B may include communication software, such as, for example, a social media and/or social network client application and/or an OSP client application.

The social media and/or social network host system 310 has an architecture that enables the devices (e.g., servers) within the social media and/or social network host system 310 to communicate with each other. To transfer data, the social media and/or social network host system 310 employs one or more standard or exclusive social media and/or social network protocols.

The lead user system 305A may establish a connection to the login server 470 in order to access the social media and/or social network host system 310 and begin a social media and/or social network session. The login server 470 typically determines whether the particular lead user is authorized to access the social media and/or social network host system 310 by verifying the lead user's identification and password.

In one implementation, the lead user system 305A may transmit media content, and/or data, to and access content from the social media and/or social network server 490 once a connection to the social media and/or social network server 490 has been established.

By accessing the social media and/or social network server, a lead user can leverage the social media and/or social network client application to ECHO (i.e share, re-share, post, repost, distribute, redistribute) content of interest, track Echos (i.e., shares, re-shares, posts, reposts, distributes, redistributes), check ECHO (i.e share, re-share, post, repost, distribute, redistribute) status reports, follow users, create content, create product media CTA and/or products, upload content, participate in groups, find other users with similar interests, get customized information and other functions within social media and/or social network host systems.

The media content which is delivered by the ECHO (i.e share, re-share, post, repost, distribute, redistribute) function between lead user system 305A and follower system 305B may be routed through social media and/or social network host system 310.

The social media and/or social network host system 310 may include a user profile server (not shown) connected to a database (not shown) for storing large amounts of user profile data. The user profile server may be used to enter, retrieve, edit, manipulate, or otherwise process user profile data. In one implementation, a user's profile data includes, for example, the user's name, username, nickname or handle for the purposes of defining the users profile address. In another implementation, a user's profile data include friends and/or follower list, location and interests. Systems similar to those shown by FIGS. 3 and 4 may be used to enable similar functionality with respect to non-social media and/or social network schemes, for example, such as the typed described with respect to FIG. 2.

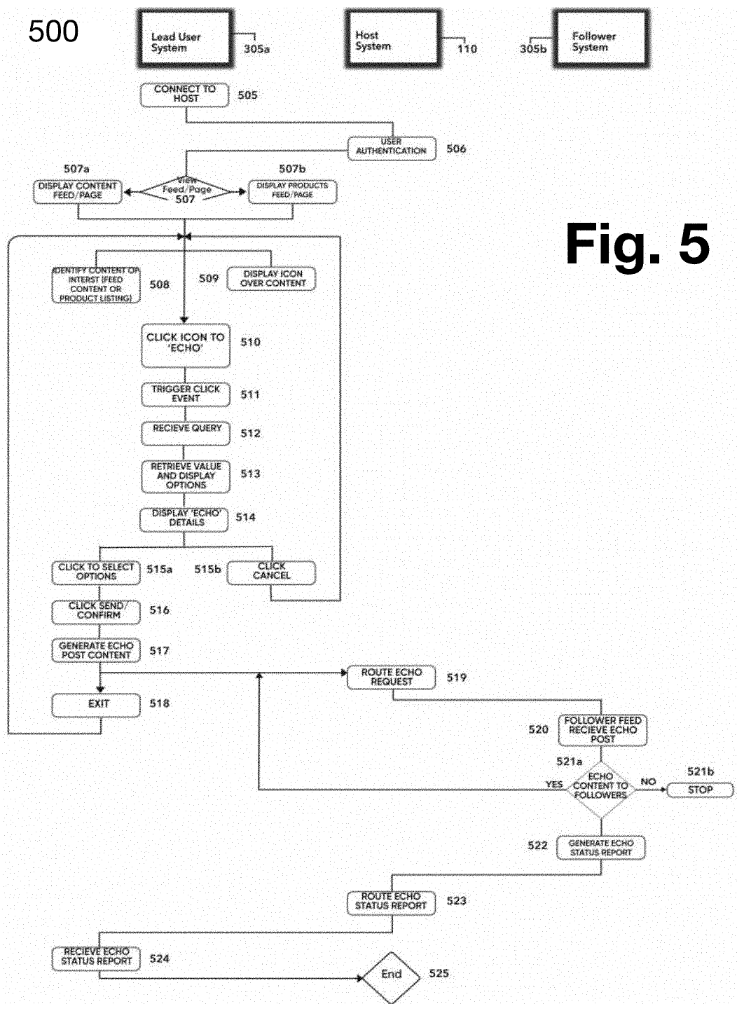

Referring to FIG. 5, the lead user system 305A, the follower system 305B, and the host system 110 interact according to exemplary procedure 500 to ECHO (i.e., share, re-share, post, repost, distribute, redistribute) the media content of interest from a lead user feed, and/or display, with all followers. The procedure 500 may be implemented by any type of hardware, software, device, computer, computer system, equipment, component, program, application, code, storage medium, or propagated signal. Furthermore, although not shown in FIG. 5, the lead user system 305A, the follower system 305B, and the host system 110 may be interconnected through known or described delivery networks, examples of which are described with respect to network 160.

The procedure 500 may be implemented in a client/host context, or a standalone client context. The media content of interest may be Echoed (i.e., shared, re-shared, posted, reposted, distributed, redistributed) by the standalone device and may be accessed or updated through a remote device in a non-client/host environment, such as, for example, a LAN server serving an end user or a mainframe serving a terminal device. Thus, the procedure 500 described below may be implemented for an OSP, ISP, browser and/or other software program, such as programs for social media and/or social networks, media players, game consoles and stand-alone browsers.

Procedure 500 involves Echoing (i.e., sharing, re-sharing, posting, reposting, distributing, redistributing) media content from a lead user feed and/or display with all followers. While some functions of procedure 500 may be performed entirely by the lead user system 305A or the follower system 305B, other functions may be performed by the host system 110 or the collective operation of the lead user system 305A, the follower system 305B, and/or the host system 110. The host system 110 may be, for example a social media and/or social network host system 310.

Referring to FIG. 5, in the procedure 500, the lead user system 305A and the host system 110 are physically and/or logically connected (step 505). For instance, lead user system 305A may connect to the host system 110 across a network (e.g., network 160) by supplying a lead user identification and password (e.g. user authentication 506) to a server (e.g., a login server) in order to obtain access to the host system 110.

Media content being viewed (step 507) in one or more pages (e.g.. lead user content feed 507A or a product media CTA and/or product listing in a product media CTA and/or products page or in an e-commerce marketplace 507B) interacted with, purchased and/or experienced (i.e., being made perceptible to the user) on the lead user system 305A then is identified (step 508) as the content and/or product media CTA and/or product of interest. The media content is identified manually by the lead user, for example. the lead user scrolls through the lead user feed and/or page until media content of interest Is located. Lead users views and/or interacts with and/or purchases and or experiences the media content of interest and locates the displayed icon that resides over the content 509 on the lead user system 305A.

The media content of interest can be Echoed (i.e., shared, re-shared, posted, reposted, distributed, redistributed) only when lead user clicks the ECHO icon (step 510) which triggers a click event 511 after which the host system 110 receives the query 512, retrieves the value and displays an ECHO modal and/or page with options 513 with the details for, the current, content a lead user wants to ECHO and/or displays lead user previous ECHO data and/or statistics and/or information and may highlight the total number of Echos a lead user has delivered in any given time period (e.g., day, days, week, month, year) 514.

In the instance a lead user wishes to proceed with the ECHO (i.e., share, re-share, post, repost, distribute, redistribute), a lead user can select any options corresponding with creating and/or delivering an Echo, viewing previous ECHO data, total ECHO data and/or information of all lead user Echos and/or creating a description and/or title for the ECHO post 515A.

In the instance the lead user wishes to exit and not move forward with an Echo, the lead user can click a cancel button 515B which reverts the lead user back to the initial view of the media content of interest (step 508).

In the instance the lead user wishes to proceed with the Echo, the lead user can select any option corresponding with creating the ECHO (i.e. viewing previous ECHO data, total ECHO data and/or information of all lead user Echos and/or creating a description) 515A, after which lead user clicks a send and/or confirm button (step 516) on the lead user system 305A that generates the ECHO post 517.

In the instance that the lead user system 305A generates an ECHO post 517, the lead user system 305A then exits (step 518) the ECHO modal and/or page, reverting the lead user back to the initial view of the media content of interest (step 508) and simultaneously the host system 110 routes the ECHO content request (step 519).

Next, the follower system 305b receives the ECHO content (step 520) making it perceptible to all of a lead users followers where those users within the follower system can view and/or access, and/or purchase from and/or experience and/or ECHO the media content (step 521A) or not ECHO (step 521B) the media content, for content referral marketing rewards, traffic engagement and/or providing new content for their followers as well. Next, the follower system 305B generates an ECHO status report (step 522) with follower engagement data (e.g., views and/or purchases and/or interactions) and an indication on how the ECHO performs throughout the media contents life cycle.

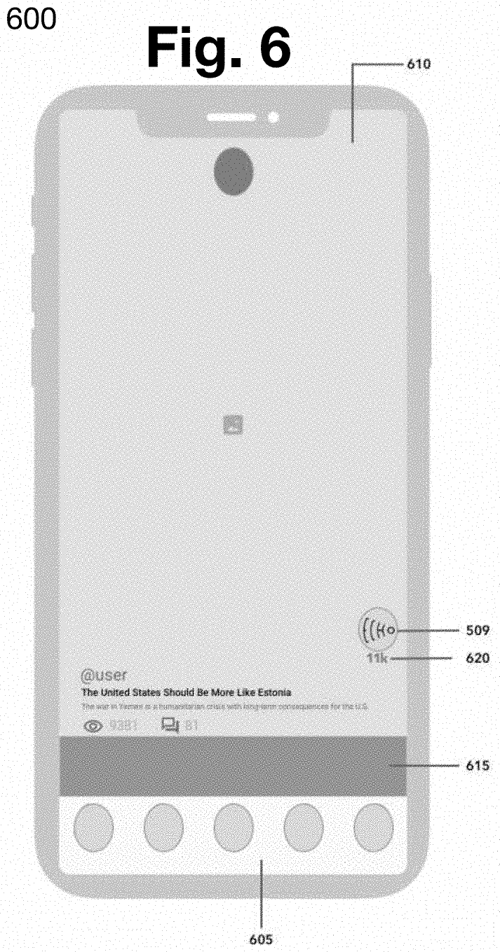

Next, the host system 110 routes the ECHO status report (step 523) and the lead user receives the ECHO status report (step 524) on the lead user system 305A then end process (step 525). FIG. 6 illustrates one particular scenario in which an application can be used as a basis for identifying media content of interest.

In particular, FIG. 6 illustrates one example of a user interface (UI) 600 that may be presented to a lead user for enabling the lead user to view and/or interact with and/or engage with, media content. The UI 600 includes a social media network feed 605 configured to build social relationships and display media content from users making it perceivable to the lead user.

In general, the UI 600 is rendered on the lead user system 305A using software stored on the lead user system 305A. The media content to be viewed and/or accessed and/or experienced by the follower system 305B may be stored on the lead user system 305A, the media content to be Echoed (i.e., shared, re-shared, posted, reposted, distributed, redistributed) by the lead user may be stored on the host system 110.

As shown, the social media network feed 605 displays the media content currently being viewed and/or interacted with and/or experienced 610 which is the content of interest identified by the lead user (step 508). Also displayed, is an assigned advertisement 615 attached to the content of interest and an ECHO icon and/or button 509 that allows a lead user to ECHO the content of interest currently being viewed and/or interacted with and/or experienced. Also displayed is an identifier 620, that allows a follower to know the content was Echoed, and how many times, by a lead user.

In one implementation, the content of interest being viewed and/or interacted with and/or experienced can be Echoed to the host system 110 by the lead user system 305A. The host system 110 may then deliver the content being viewed and/or interacted with and/or experienced by the lead user, to all followers in the follower system 305b in which an ECHO status report is generated (step 522) with ECHO data and/or information and/or ECHO tracking information.

In another implementation content has an assigned advertisement 615 that will accompany an ECHO during the content life cycle. The generated ECHO status report (step 522) of an ECHO with an assigned advertisement 615 tracks and/or records the revenue generated by the assigned advertisement and/or tracks and/or records the purchases of a product media CTA and/or product made by followers and/or amount of sells accumulated from an ECHO of the content of interest.

As shown, the social media network feed 605 displays the media content currently being viewed and/or interacted with and/or experienced 610 and contains an identifier 620, that allows a follower to know the content was Echoed, and how many times, by a lead user.

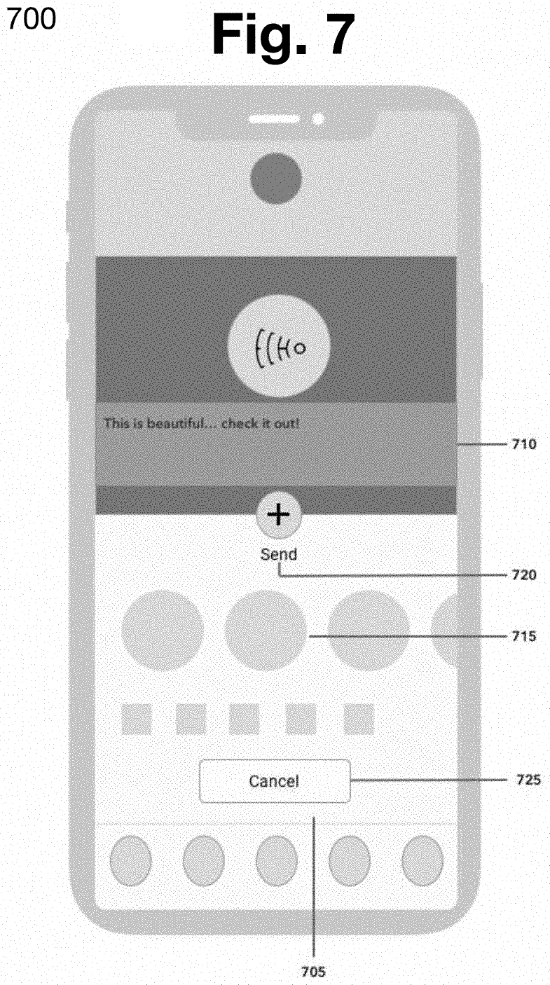

FIG. 7 illustrates one example of a UI 700 for generating an Echo. In particular, the lead user may generate an ECHO to be sent to all followers feed in a follower system by invoking an ECHO interface (UI) 705. The ECHO interface UI 705 includes a compose area 710 where the lead user may compose a caption and/or description. The lead user may view previous ECHO history and/or data by selecting an option in the ECHO history area 715, which contains a log of data and/or information gathered by the users previous Echos generated and/or sent. Also displayed are controls for sending an ECHO 720 or canceling an ECHO 725.

In the event the lead user clicks send 720, the ECHO will be generated and routed to the host system 110, then to the follower system 305b (step 519) delivering the content of interest to the feed of all followers (step 520) where all followers can view and/or access, and/or purchase from and/or experience and/or ECHO (step 521a) the lead users content of interest (step 508). In the event the lead user clicks cancel 725 the lead user will revert back and/or be directed back to the content of interest.

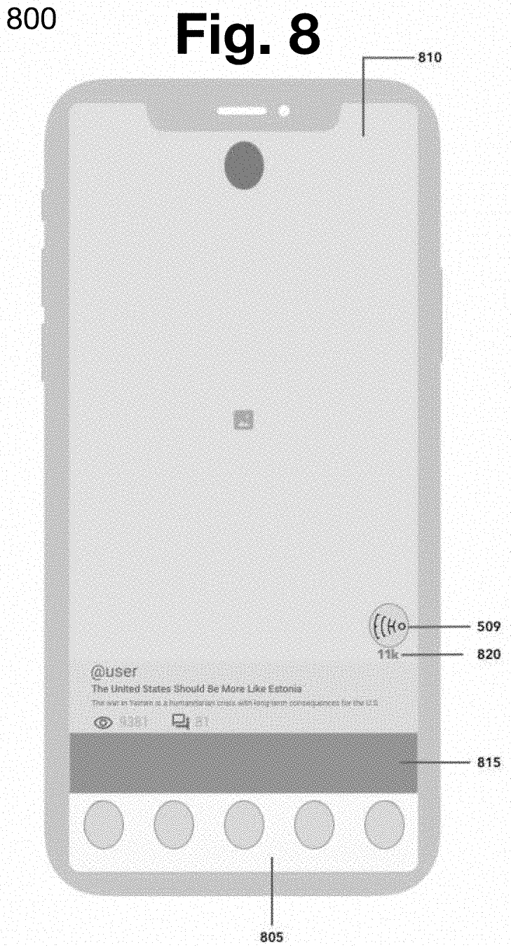

FIG. 8 illustrates one particular scenario in which a follower receives the ECHO of the media content and is viewing it in a feed. In particular, FIG. 8 illustrates an example of a UI 800 that may be presented to a follower for enabling the follower to view and/or access and/or purchase from and/or experience the media content of a lead user. As with UI 600 discussed above, the UI 800 includes a social media network feed 805 configured to access the media content and make it perceivable to the follower. In general, the UI 800 is rendered on the follower system 305B using software stored on the follower system 305B.

As shown, the social media network feed 805 includes a window that displays the media content currently being viewed and/or interacted with and/or experienced 810. Next the follower system generates a status report (step 522) that collects data and/or stores data and/or tracks data about views, follower interaction and/or engagement, and/or revenues accumulated and/or revenues earned and/or revenues generated from the advertisement 815 attached to Echoed media content of interest. An ECHO (i.e share, re-share, post, repost, distribute, redistribute) status report also tracks data and/or stores data and/or collects data corresponding to revenues earned from sales made and/or purchases made from the content of interest by all followers.

An ECHO status report is generated to indicate the interaction and/or engagement of the followers (step 522). The results of the ECHO status report may be displayed to the lead user and/or to the follower. The ECHO status report may be updated as needed. For example, if the follower decides to purchase from the content and/or ECHO the content an updated sharing status report may be generated to reflect the updated status. The ECHO status report may include a visual identifier, such as a chart and/or graph 715 to indicate the traction and/or activity of a Lead user echos.

The ECHO (i.e share, re-share, post, repost, distribute, redistribute) status report is routed to the lead user system 305A by the host system 110 (step 522). In one implementation, the host system routes the ECHO status report directly to the lead user. In another implementation, the host system routes the ECHO status report to one or more intermediaries, before the ECHO status report is routed to the lead user. In yet another implementation, the follower system 305B may route the ECHO status report directly to the lead user system 305A, without routing the report through the host system 110. In one implementation, the host stores the ECHO status information for designated users, and updates the sharing status for the designated users. One form of a ECHO status report involves a UI presented to the lead user (not shown).

Also displayed is an ECHO icon and/or button 509 to ECHO the content of interest currently being viewed and/or interacted with and/or experienced. Also displayed is an identifier 820, that allows a follower to know the content was Echoed, and how many times, by a lead user.

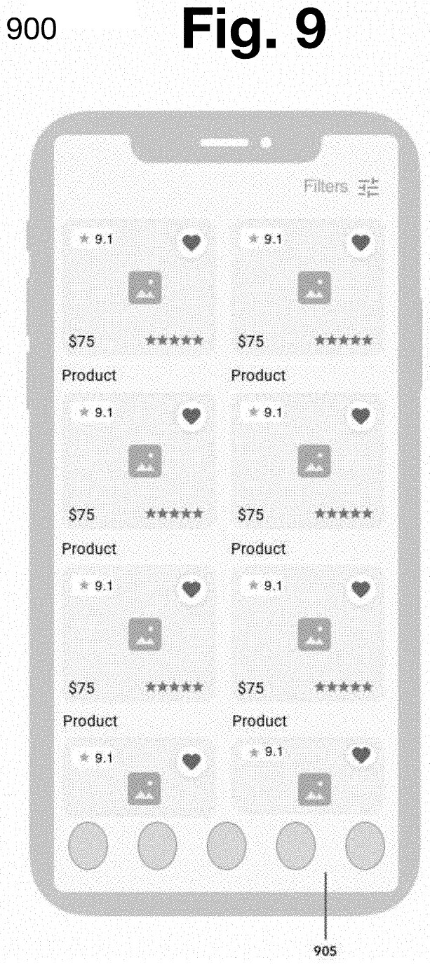

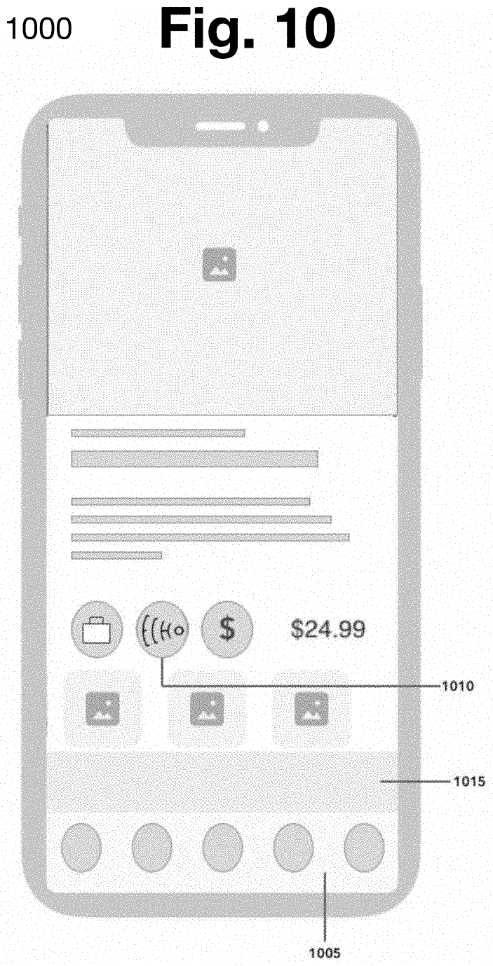

FIGS. 9 and 10 illustrate examples of UIs 900 and 1000 for enabling a follower to view product media CTA and/or products in a marketplace, purchase product media CTA and/or products and/or ECHO product media CTA and/or products from a product media CTA and/or product listing UI 1005. FIG. 9 displays an UI 900 for enabling a user to look through product media CTA and/or products within a product media CTA and/or product marketplace 905 and FIG. 10 displays an UI 1000 of a product media CTA and/or product listing 1005.

The UI 900 includes a product media CTA and/or product marketplace 905 configured to access product media CTA and/or products and make them perceivable to the user.

The product media CTA and/or product marketplace UI 905 includes a product media CTA and/or product grid 910 or a product media CTA and/or product list (not shown) where the user may browse product media CTA and/or products in the entire marketplace. As shown in FIG. 10, a product media CTA and/or product listing UI 1005 may be invoked in the event a user clicks a product media CTA and/or product of interest where the product media CTA and/or product details can be viewed, where the product media CTA and/or product can be purchased and/or added to a cart and/or Echoed.

Also displayed, is an ECHO icon and/or button 1010 that allows a user to ECHO the product media CTA and/or product of interest. Also displayed is an assigned advertisement 1015 attached to the product media CTA and/or product of interest. In the example of FIG. 10 a product media CTA and/or product has an assigned advertisement 1015 that will accompany an ECHO during the product media CTA and/or product listing life cycle. The generated status report (step 522) of an ECHO with an assigned advertisement 1015 tracks and/or records the revenue generated by the assigned advertisement and/or tracks and/or records the purchases of a product media CTA and/or product made by followers and/or amount of sells accumulated from an ECHO of the product media CTA and/or product of interest.

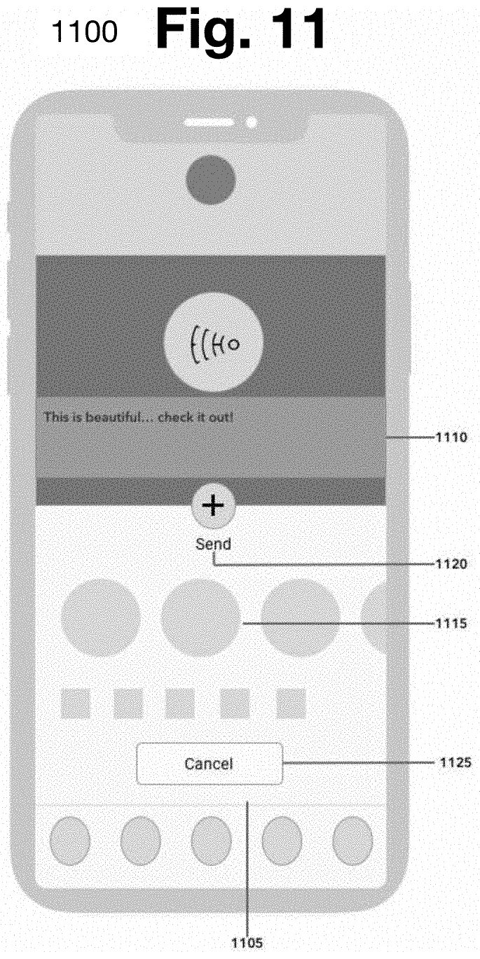

FIG. 11 illustrates an example of a user interface (UI) 1100 that may be presented to a lead user. As with UI 700 discussed above, the UI 1100 is for generating an Echo. In particular, the user may generate an ECHO to be sent to all followers feed in a follower system by invoking an ECHO interface (UI) 1105. The ECHO interface UI 1105 includes a compose area 1110 where the lead user may compose a caption and/or description. The lead user may view previous ECHO history and/or data by selecting an option in the ECHO history area 1115, which contains a log of data and/or information gathered by the users previous Echos (i.e shares, re-shares, posts, reposts, distributes, redistributes) generated and/or sent. Also displayed are controls for sending an ECHO 1120 or canceling an ECHO 1125.

In the event the lead user clicks send 1120, the ECHO (i.e share, re-share, post, repost, distribute, redistribute) will be routed to the host system 110, then to the follower system 305b (step 519) delivering the content of interest to the feed of all followers (step 520) where all followers can view and/or access, and/or purchase from and/or experience and/or ECHO (step 521a) the lead users content of interest (step 508). In the event the lead user clicks cancel 1125 the lead user will revert back to the content of interest. Once delivered the Echoed content of interest and/or product media CTA and/or product contains an identifier (not shown) that allows a user to know the product media CTA and/or product was Echoed.

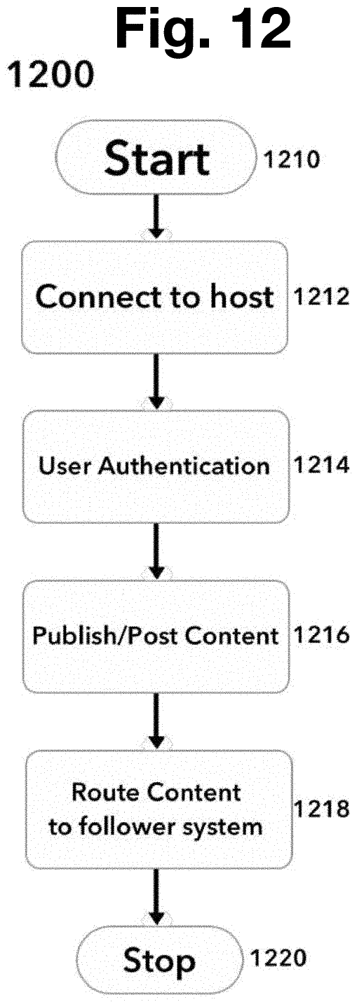

FIG. 12 illustrates on example of a media content and/or a product media CTA and/or product publishing system 1200 where a publishing lead user enters a lead user system 305A and/or opens an application and/or visits a website and/or enters a social media network (step 1210), connects to the host system 1212, authenticates the user info 1214 and publishes media content and/or a post 1216. Upon publishing the media content and/or posting the media content the content is then routed from the lead user system 305A to the host system 110 and then to the follower system 305B (step 1218), then the process ends (step 1220).

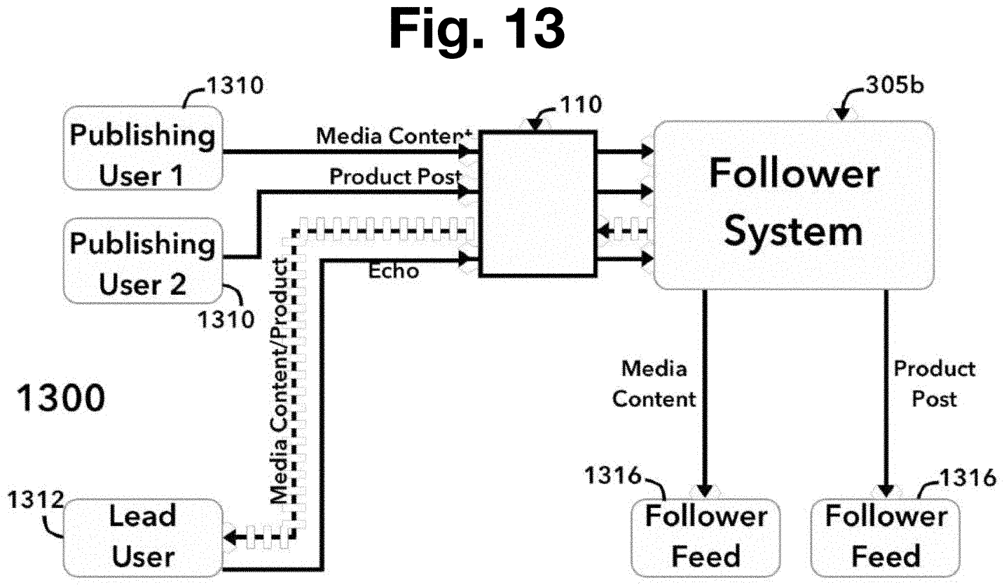

FIG. 13 illustrates a media content and/or a product media CTA and/or product publishing system 1300 where multiple publishing lead users 1310 are publishing media content and/or a product media, CTA and/or product to the host system 110 which is routed to the follower system 305B then to all of the publishing lead users followers 1316. Also illustrated is a lead user within a follower system receiving the media content and/or a product media CTA and/or product from the host system 110 routed from the follower system 305B to a lead users feed and/or display page.

Also illustrated is a lead user performing an ECHO 1312 of the publishing lead users media content and/or a users product media CTA and/or product which is routed to the host system 110 then routed to the follower system 305B where all of the lead users followers feed receives the media content and/or the product media CTA and/or product 1316.

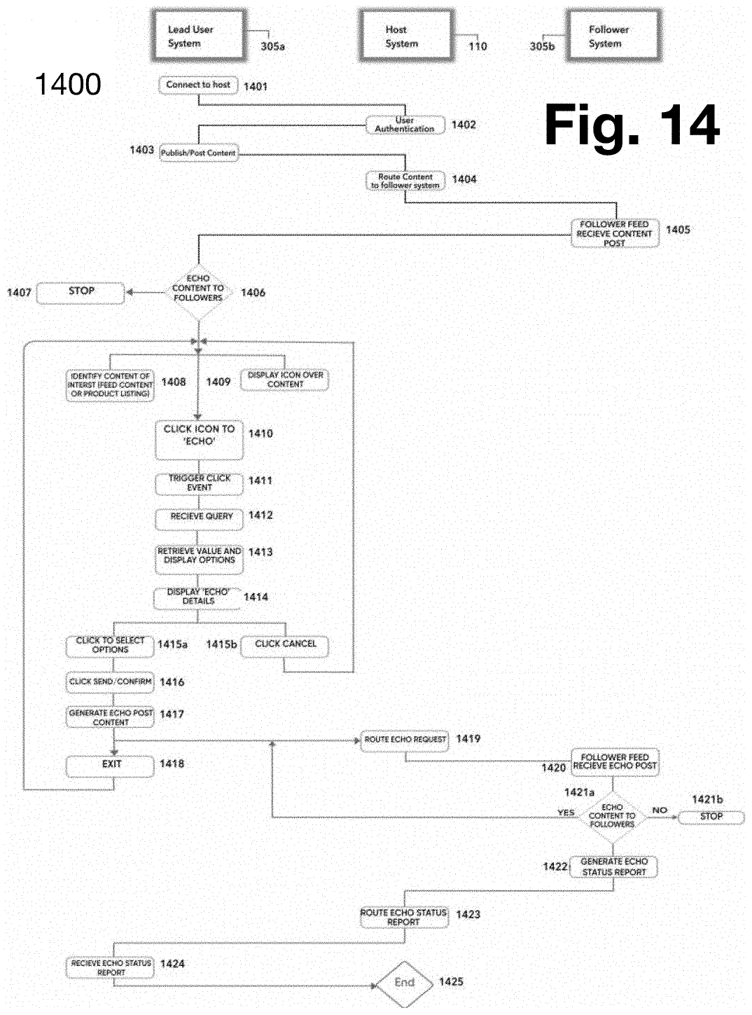

Referring to FIG. 14, systems similar to those shown by FIG. 5 may be used to enable similar functionality with respect to a publishing lead user to publish content that is then delivered to the follower system 305B enabling any lead user the ability to ECHO the publishing lead users published content. FIG. 14 illustrates a media content publishing and media content ECHO system 1400, the process of how a published piece of content gets published and then how a lead user performs an Echo. The lead user system 305A, the follower system 305B, and the host system 110 interact according to exemplary procedure 1400 to publish media content for other lead users to ECHO (i.e., share, re-share, post, repost, distribute, redistribute).

The procedure 1400 may be implemented by any type of hardware, software, device, computer, computer system, equipment, component, program, application, code, storage medium, or propagated signal. Furthermore, although not shown in FIG. 14, the lead user system 305A, the follower system 305B, and the host system 110 may be interconnected through known or described delivery networks, examples of which are described with respect to network 160.

The procedure 1400 may be implemented in a client/host context, or a standalone client context. The media content published by a publishing lead user may be Echoed (i.e., shared, re-shared, posted, reposted, distributed, redistributed) by the standalone device and may be accessed or updated through a remote device in a non-client/host environment, such as, for example, a LAN server serving an end user or a mainframe serving a terminal device. Thus, the procedure 1400 described below may be implemented for an OSP, ISP, browser and/or other software program, such as programs for social media and/or social networks, media players, game consoles and stand-alone browsers.

Procedure 1400 involves a publishing lead user publishing media content to a follower system 305b that followers and/or other lead users are Echoing (i.e., sharing, re-sharing, posting, reposting, distributing, redistributing) from the lead user feed and/or display with all of the lead users followers. While some functions of procedure 1400 may be performed entirely by the lead user system 305A or the follower system 305B, other functions may be performed by the host system 110 or the collective operation of the lead user system 305A, the follower system 305B. and/or the host system 110. The host system 110 may be, for example a social media and/or social network host system 310.

Referring to FIG. 14, in the procedure 1400, the lead user system 305A and the host system 110 are physically and/or logically connected (step 1401). For instance, lead user system 305A may connect to the host system 110 across a network (e.g., network 160) by supplying a lead user identification and password (e.g. user authentication 1402) to a server (e.g., a login server) in order to obtain access to the host system 110.

A lead user, in this case a publishing lead user, publishes and/or posts media content 1403. The media content published and/or posted and/or created on the lead user system 305A is then routed to the host system (step 1404) where the media content is then received by the follower system (step 1405) being made perceptible to all of a publishing lead users followers in one or more pages (e.g., lead user content feed 507A or a product media CTA and/or product listing in a product media CTA and/or products page or in an e-commerce marketplace 507B).

Once the published media content is received and perceptible to all publishing lead users followers the followers become lead users enabled to interact with and/or purchase and/or experience and/or ECHO the media content 1406, or not ECHO the media content 1407, published from a publishing lead user. In the event the lead user wishes to ECHO media content published by a publishing lead user, systems shown by FIG. 5 will be used to enable the ECHO functionality.

The media content on the lead user system 305A is already identified (step 1408) as the content and/or product media CTA and/or product of interest. The media content is identified manually by the lead user, for example, the lead user scrolls through the lead user feed and/or page until published media content of interest is located. A Lead user views and/or interacts with and/or purchases and or experiences the media content of interest and locates the displayed icon that resides over the content 1409 on the lead user system 305A.

Next, the lead user clicks the ECHO icon (step 1410) which triggers a click event 1411 after which the host system 110 receives the query 1412, retrieves the value and displays an ECHO modal and/or page with options 1413 with the details for, the current, published media content a lead user wants to ECHO and/or displays lead user previous ECHO data and/or statistics and/or information and may highlight the total number of Echos a lead user has delivered in any given time period (e.g., day, days, week, month, year) 1414.

In the instance a lead user wishes to proceed with the ECHO (i.e., share, re-share, post, report, distribute, redistribute), a lead user can select any options corresponding with creating and/or delivering an Echo, viewing previous ECHO data, total ECHO data and/or information of all lead user Echos and/or creating a description and/or title for the ECHO post 1415A. In the instance the lead user wishes to exit and not move forward with an Echo, the lead user can click a cancel button 1415B which reverts the lead user back to the initial view of the media content of interest (step 1408. In the instance the lead user wishes to proceed with the Echo, the lead user can select any option corresponding with creating the ECHO (i.e. viewing previous ECHO data, total ECHO data and/or information of all lead user Echos and/or creating a description) 1415A, after which lead user clicks a send and/or confirm button (step 1416) on the lead user system 305A that generates the ECHO post 1417.

In the instance that the lead user system 305A generates an ECHO post 1417, the lead user system 305A then exits (step 1418) the ECHO modal and/or page, reverting the lead user back to the initial view of the media content of interest (step 1408) and simultaneously the host system 110 routes the ECHO content request (step 1419). Next, the follower system 305b receives the ECHO content (step 1420) making it perceptible to all of a lead users followers where those users within the follower system can view and/or access, and/or purchase from and/or experience and/or ECHO the media content employing systems shown by FIG. 5 (step 1421A) or not ECHO (step 1421B) the media content, for content referral marketing rewards, traffic engagement and/or providing new content for their followers as well.

Next, the follower system 305B generates an ECHO status report 1422 with follower engagement data (e.g., views and/or purchases and/or interactions) and an indication on how the published media content and/or the Echos of the published media content performs throughout the media contents life cycle. Next, the host system 110 routes the ECHO status report 1423 where the publishing lead user, and/or any other lead user that performs an ECHO of the publishing lead users media content, receives an ECHO status report 1424 on the lead user system 305A then end process (step 1425).

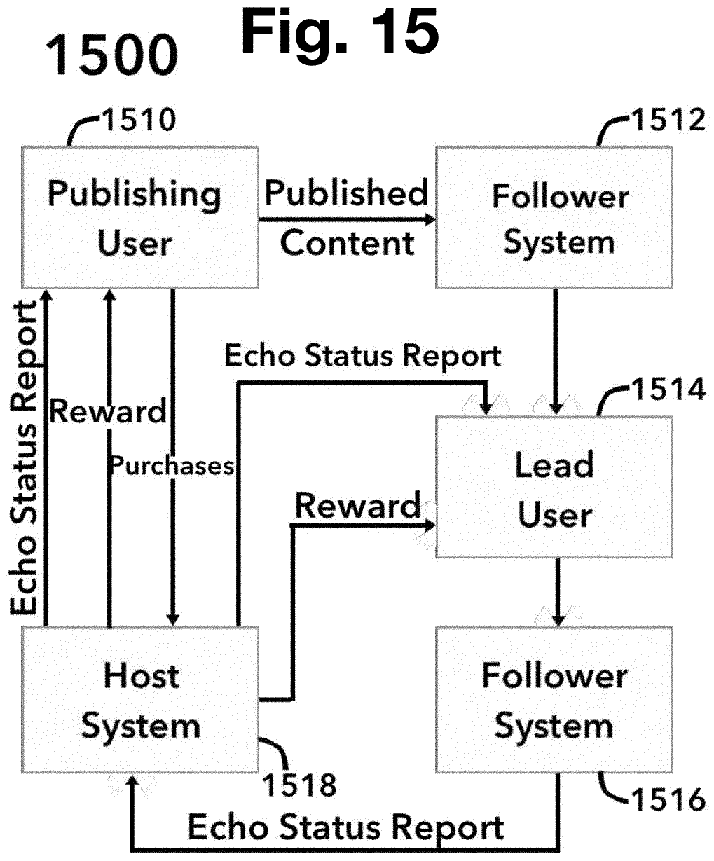

FIG. 15 Procedure 1500 illustrates a system for delivering ECHO status reports and distributing rewards and/or compensations and/or commissions to publishing lead users 1510 and a lead user 1514. A publishing lead user 1510 that publishes and/or posts media content and/or a product media CTA and/or product gets routed to a follower system 1512 enabling followers of the publishing lead user to ECHO the media content and/or a product media CTA and/or product, as a lead user 1514, to the follower system occupied by all of the lead users followers 1516.

When the ECHO is performed an ECHO status report is generated and routed to the host system 110 (step 1518). The ECHO status report tracks the ECHO performance, engagement, user interaction, ad engagement, ad revenue generated, and/or purchases. The data within the ECHO status report determines the reward to be distributed to both the publishing lead user and the lead user that performed an ECHO of a publishing lead users published and/or posted media content and/or product media CTA and/or product.

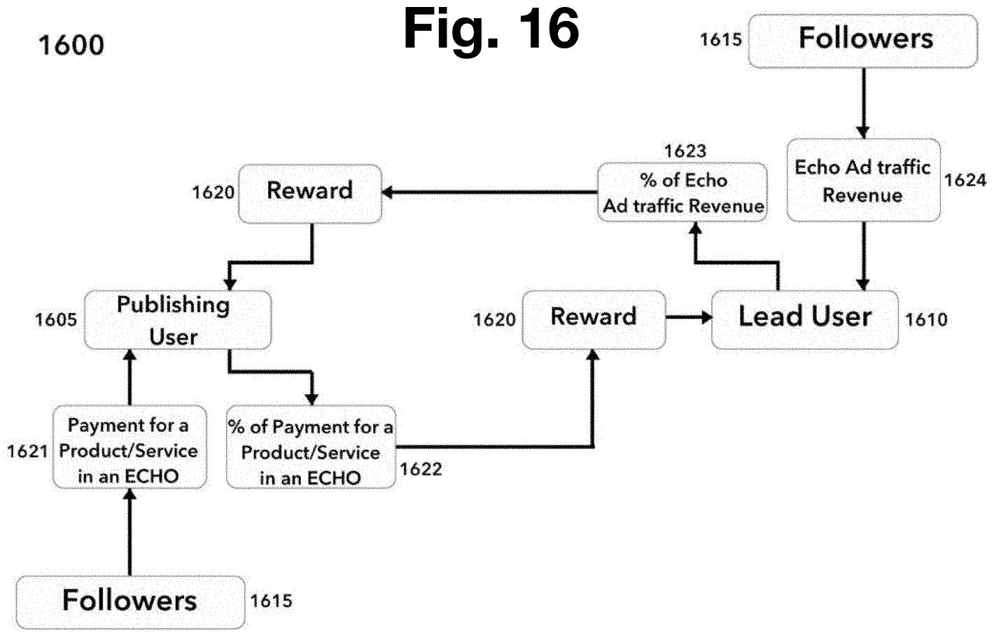

For illustrative purposes, FIG. 16 shows an example of a reward system 1600 for implementing a publishing lead user 1605 reward in a reward system and also implementing a reward for a lead user 1610 that performs an ECHO of a publishing lead users media content in a reward system. Rewards are generated from the engagements of followers 1615. Illustrated are examples of a reward distribution generated by a lead users 1610 follower engagement. A reward 1620 for a lead user is determined by a payment and/or payments and/or purchases derived from a lead user 1610 ECHO of media content and/or a product CTA and/or a product item, for a product and or service (step 1621) which is collected by and/or paid to and/or delivered to the publishing lead user 1605 and recorded in and/or tracked by the ECHO status report. Next a percentage of the payment and/or payments and/or purchases derived from a lead user 1610 ECHO for a product and/or service (step 1622) is rewarded 1620 and routed to the lead user 1610 that performed the ECHO of the publishing lead users media content and/or product CTA and/or product.

A reward 1620 for a publishing lead user 1605 is determined by the ad revenue of a lead users ECHO 1624 of media content and/or a product CTA and/or a product item. Ad clicks and/or traffic and/or the amount of followers 1615 reached with an Echo, that has an ad, of a lead user 1610 determines the revenue generated which is collected by and/or paid to and/or delivered to the lead user 1610 who performed an ECHO and recorded in and/or tracked by the ECHO status report. Next a percentage of an ECHO ad revenue 1623 derived from a lead user 1610 ECHO of media content and/or a product CTA and/or a product is rewarded 1620 and routed to the publishing lead user for providing the media content that delivered the advertisement to a lead users followers 1615.

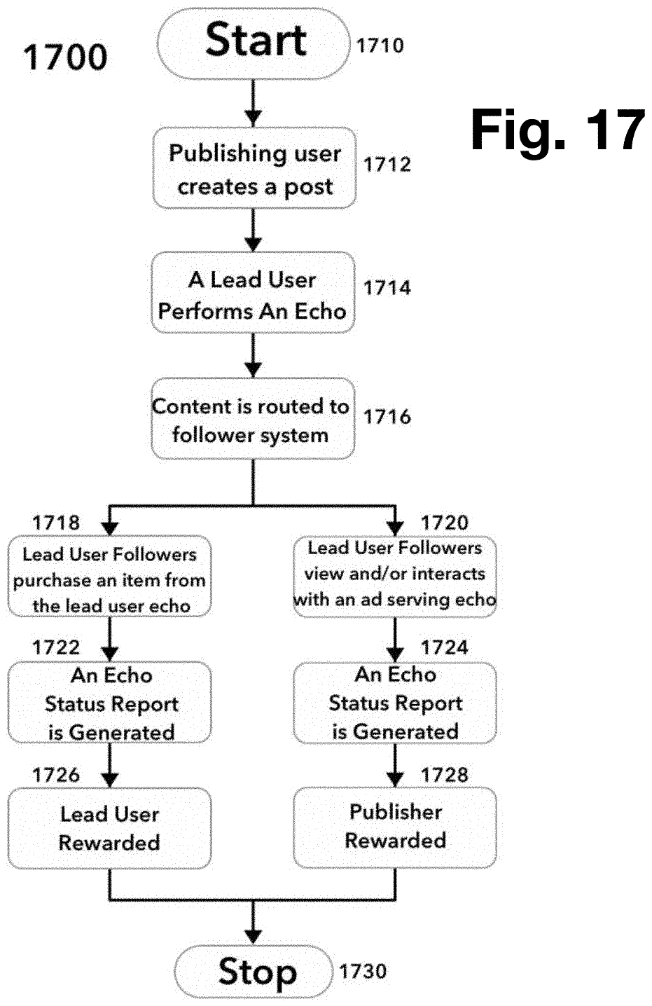

FIG. 17 Procedure 1700 illustrates a publishing lead user reward system and a lead user, that performs an echo, reward system. Procedure 1700 illustrates a media content publishing and published media content ECHO system similar to that shown by FIG. 16 used to enable functionality (step 1710) with respect to a publishing lead user 1712 publishing media content that is then delivered to the follower system 305B enabling any lead user the ability to ECHO the publishing lead users published content 1714 which is as well routed to a follower system 305B (step 1716).

In one reward example a lead user, that performs an Echo, followers make a payment and/or a purchase in and/or from media content and/or a product CTA and/or a product item item from the lead user ECHO 1718, next an ECHO status report is generated 1722 and the lead user is rewarded 1726. In another reward example a lead user, that performs an Echo, followers view and/or click an ad served and/or delivered with an ECHO of a publishing lead users media content and/or a product CTA and/or a product item in which ad revenues are derived from (step 1720) generate an ECHO status report 1724 and then the publishing lead user of the content is rewarded 1728, then procedure stops 1730.

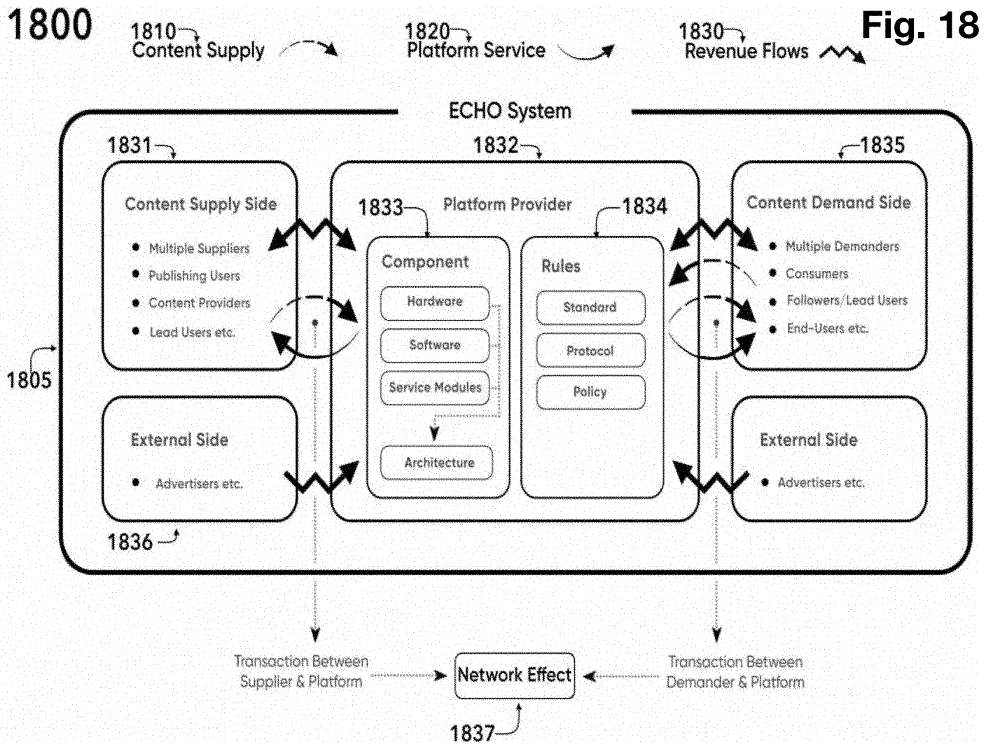

FIG. 18 illustrates a communications system 1800, the process of an Electronic Content Hortatory Operation (ECHO) 1805. The Media Content Supply System 1810, the Platform Service System 1820, and the Revenue Flow System 1830 interact according to exemplary ECHO System procedure 1805 to publish media content for other lead users and/or end users to ECHO (i.e., share, re-share, post, report, distribute, redistribute).

The Media Content Supply System 1810, the Platform Service System 1820, and the Revenue Flow System 1830 interact according to exemplary ECHO System procedure 1805 that utilizes and/or includes a content supply side 1831 from which the media content supply 1810 emanates and flows from which is delivered to the content demand side 1835 by way of the operating components 1833 and rules 1834 utilized and/or enacted by the platform provider 1832.

Revenue flows 1830 flow from and to the content supply side via the platform provider 1832, revenue flows out to the platform provider 1832 where it is tracked and/or recorded in an ECHO Status Report that is performed by the operating components 1833 and rules 1834 utilized and/or enacted by the platform provider 1832.

The revenue flows 1830 are then rewarded to users on the content demand side 1835 that have performed an ECHO of published media content derived from the content supply side 1831 wherein the ECHO has generated new product and/or service purchases for the publishing user on the content supply side 1831.

Revenue flows in to the content supply side 1831 from the platform provider 1832 after it is it is tracked and/or recorded in an ECHO Status Report that is performed by the operating components 1833 and rules 1834 utilized and/or enacted by the platform provider 1832. Revenue flows 1830 from new purchases derived from an ECHO and also from a share and/or percentage of the ECHO ad revenues generated are rewarded to users on the content supply side 1831 for being the original creator of the media content driving ad traffic for a user on the content demand side 1835 who performed an ECHO, the ad acts as a sponsor for the distribution of the media content.

For illustrative purposes FIG. 18 shows the content demand side 1835 also having the ability to supply content derived from the content supply side 1831 to the content demand side 1835, the media content supply 1810 emanates and flows from the content demand side 1835 only after an ECHO has been performed which delivers the media content back into the content demand side 1835 by way of the operating components 1833 and rules 1834 utilized and/or enacted by the platform provider 1832.

For example an user from the content supply side 1831 publishes media content which is delivered by the platform provider 1832 to the content demand side 1835 where users have the ability to view and/or interact with and/or purchase from and/or access and/or ECHO the media content. Users from the content demand side 1835 that choose to ECHO the same media content are then delivering the media content back into the content demand side 1835 essentially republishing the media content to all of their followers feeds by way of the operating components 1833 and rules 1834 utilized and/or enacted by the platform provider 1832. The content demand side user performs the ECHO for the purpose of marketing and giving their followers the ability to view and/or interact with and/or purchase from and/or access and/or ECHO the media content of the initial publishing user for a reward (i.e ad revenue and/or rewards for purchases derived from the ECHO).

Within the ECHO system transactions between the content supply side 1831 and the platform provider 1832 and transactions between the content demand side 1835 and the platform provider 1832 contribute to what is referred to as network effect 1837. A network effect 1837 is the effect described in economics and business that an additional user of goods or services, in this case media content included, has on the value of that product, service and/or media content to other users. When a network effect is present, the value of a product and/or service and/or media content increases according to the number of other users using, purchasing and/or interacting with it.

The procedure 1805 may be implemented by any type of hardware, software, device, computer, computer system, equipment, component, program, application, code, storage medium, or propagated signal. Furthermore, although not shown in FIG. 18. the lead user system 305A, the follower system 305B, and the host system 110 may be interconnected through known or described delivery networks. The procedure 1800 may be implemented in a client/host context, or a standalone client context.

The media content published by a publishing lead user may be Echoed (i.e., shared, re-shared, posted, reposted, distributed, redistributed, published, republished) by the standalone device and may be accessed or updated through a remote device in a non-client/host environment, such as, for example, a LAN server serving an end user or a mainframe serving a terminal device. Thus, the procedure 1800 described below may be implemented for an OSP, ISP, browser and/or other software program, such as programs for social media and/or social networks, media players, game consoles and stand-alone browsers.

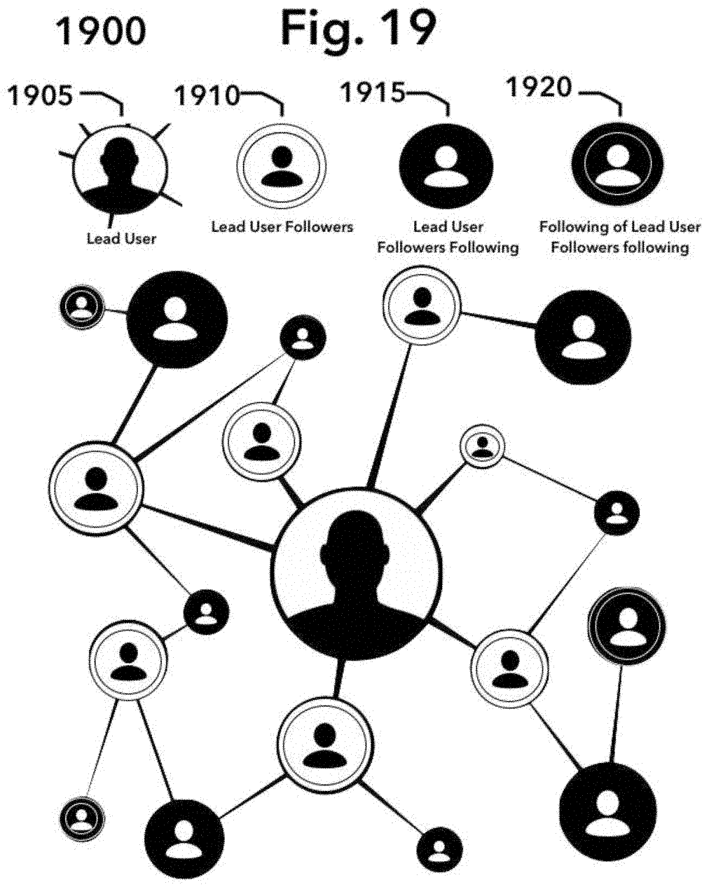

For illustrative purposes FIG. 19 shows an ECHO distribution system 1900. A lead user 1905 performs an ECHO of media content, published by a publishing lead user, delivering and/or marketing the media content to all of the lead user followers 1910 and/or followers feeds simultaneously. The lead users followers receive the ECHO content making it perceptible to all of a lead users followers 1910 where those users can view and/or access, and/or purchase from and/or experience and/or ECHO the media content for content referral marketing rewards, traffic engagement and/or providing new content for their followers as well.

Next, lead user followers 1910 perform an ECHO of the initial published media content from the ECHO of the initial lead user, published by a publishing lead user, delivering and/or marketing the media content to all of the lead user followers following 1915 and/or followers feeds simultaneously. The lead users followers following 1915 receive the ECHO content making it perceptible to all of a lead users followers following 1915 where those users can view and/or access, and/or purchase from and/or experience and/or ECHO the media content for content referral marketing rewards, traffic engagement and/or providing new content for their followers as well.

Next, lead user followers following 1915 perform an ECHO of the initial published media content from the ECHO of the initial lead user, published by a publishing lead user, delivering and/or marketing the media content to all of the following of lead user followers following 1920 and/or followers feeds simultaneously. The following of lead users followers following 1920 receive the ECHO content making it perceptible to all of a following of lead users followers following 1920 where those users can view and/or access, and/or purchase from and/or experience and/or ECHO the media content for content referral marketing rewards, traffic engagement and/or providing new content for their followers as well, so on and so forth.

Obviously, many modifications and variations of the present invention are possible in light of the above teachings. Thus, it is to be understood that, within the scope of the appended claims, the invention may be practiced otherwise than as specifically described above. Other implementations are within the scope of the following claims.

What is claimed and desired to be secured by a Letters Patent of the United States is:

1. A computer and/or software and/or application and/or mobile implemented method comprising: identifying online media content of interest presently being viewed and/or interacted with and/or engaged with and/or purchased from and/or experienced by a lead user linked to a plurality of followers within a social network and/or social media network; determining an attribute associated with the online media content presently being experienced by the lead user; Ability to ECHO (i.e share, re-share, post, repost, distribute, redistribute, publish, republish) the online media content presently being experienced by the lead user with all followers; and in response of a determination to ECHO (i.e share, re-share, post, repost, distribute, redistribute, publish, republish) the online media content of interest presently being viewed and/or interacted with and/or engaged with and/or purchased from and/or experienced by the lead user with all followers: Display on and/or push and/or post the content presently being viewed and/or interacted with and/or engaged with and/or purchased from and/or experienced by the lead user to all followers feed and/or display; and enabling all followers to view and/or interact with and/or engage with and/or purchase from and/or experience the online media content experienced by the lead user; and allow followers to ECHO the previously Echoed media content; Also to record statistics and/or data and/or information (e.g. engagement, purchases, revenues, views) of an echo; and display an ECHO icon over content that allows a user to ECHO the content of interest; and Echoed.

2. The method of claim 1, further comprising to make available to all followers the online media content of interest presently being viewed and/or interacted with and/or engaged with and/or purchased from and/or experienced by the lead user.

3. The method of claim 1, comprises enabling all followers to view and/or interact with and/or engage with and/or purchase from and/or experience the online media content presently being viewed and/or interacted with and/or engaged with and/or purchased from and/or experienced by the lead user automatically based upon a machine-to-machine communication without intervention by the followers.

4. The method of claim 1, wherein enabling all followers to view an ECHO icon associated with the online media content of interest presently being viewed and/or interacted with and/or engaged with and/or purchased from and/or experienced by the lead user.

5. The method of claim 1, further comprising a display to all followers of online media content previously viewed and/or interacted with and/or engaged with and/or purchased from and/or experienced by the lead user how many times the content was Echoed

6. The method of claim 1, wherein collecting data records the information and/or statistics of previous Echos and/or total Echos data of lead user Echos.

7. The method of claim 1, further comprising allowing all followers of online media content previously viewed and/or interacted with and/or engaged with and/or purchased from and/or experienced and Echoed by a lead user the ability to ECHO the media content Echoed by a lead user.

8. A system comprising:
at least one processor; a memory device coupled to the at least one processor, the memory device storing instructions which, when executed by the at least one processor, cause the processor to: Identify online media content of interest presently being viewed and/or interacted with and/or engaged with and/or purchased from and/or experienced by a lead user linked to a plurality of followers within a social network; determining an attribute associated with the online media content presently being experienced by the lead user;
Ability to ECHO (i.e. share,) the online media content presently being experienced by the lead user with all followers; and in response of a determination to ECHO (i.e. share,) the online media content of interest presently being viewed and/or interacted with and/or engaged with and/or purchased from and/or experienced by the lead user with all followers: Display on and/or push and/or post the content presently being viewed and/or interacted with and/or engaged with and/or purchased from and/or experienced by the lead user to all followers feed and/or display; and enabling all followers to view and/or interact with and/or engage with and/or purchased from and/or experience the online media content experienced by the lead user; and allow followers to ECHO the previously Echoed media content; Also to record statistics and/or data and/or information (e.g. engagement, purchases, revenues, views) of an echo; and display an ECHO icon over content that allows a user to ECHO the content of interest; and display how many times the content has been Echoed.

9. The system of claim 8, further comprising instructions which, when executed by the at least one processor, cause the at least one processor to:
Make available to all followers the online media content of interest presently being viewed and/or interacted with and/or engaged with and/or purchased from and/or experienced by the lead user.

10. The system of claim 8, further comprising instructions which, when executed by the at least one processor, cause the at least one processor to:
enable all followers to view and/or interact with and/or engage with and/or purchase from and/or experience the online media content of interest presently being viewed and/or interacted with and/or engaged with and/or purchased from and/or experienced by the lead user automatically based upon a machine-to- machine communication without intervention by the followers.

11. The system of claim 8 further comprising instructions which, when executed by the at least one processor, cause the at least one processor to: enable all followers to view an ECHO icon associated with the online media content of interest presently being viewed and/or interacted with and/or engaged with and/or purchased from and/or experienced by the lead user.

12. The system of claim 8, further comprising instructions which, when executed by the at least one processor, cause the at least one processor to: display to all followers of online media content previously viewed and/or interacted with and/or engaged with and/or purchased from and/or experienced by the lead user how many times the content was Echoed.

13. The system of claim 8, further comprising instructions which, when executed by the at least one processor, cause the at least one processor to: collect data and record the information and/or statistics of previous Echos and/or total Echos data of lead user Echos.

14. The system of claim 8, further comprising instructions which, when executed by the at least one processor, cause the at least one processor to: allow all followers of online media content previously viewed and/or interacted with and/or engaged with and/or purchased from and/or experienced and Echoed by a lead user the ability to ECHO the media content Echoed by a lead user.

15. A social media content referral marketing system comprising:
A non transitory data storage device for storing data; at least one processor system including at least one processor programmed to handle the following steps:
(a) enable media content and/or product media CTA and/or a product to be selectively Echoed to all of a lead user, performing an ECHO, followers feeds
(b) keep track of payments and/or purchases and/or ad revenues generated or other actions by followers based upon media content and/or a product media CTA and/or a product that is Echoed by a lead user; and
(c) credit and/or distribute rewards to lead users for payments and/or purchases by the lead users followers derived from an ECHO performed by a lead user; and
(d) credit and/or distribute rewards and/or a percentage of ad revenue shares to publishing users, of media content published, for ECHO ad views and/or ECHO ad traffic and/or ECHO ad clicks

16. The Electronic Hortatory Content Operation and social media content referral marketing system as recited in claim 15 Wherein said processor is programmed to ECHO published media content and/or product media CTA and/or product and/or service of a publishing lead user to all of a lead user, performing an ECHO, followers feeds.
